(19) United States
(12) Patent Application Publication
(10) Pub. No.: US 2026/0330195 A1
(43) Pub. Date: Oct. 22, 2026

(54) PROCESSING CONTROL APPARATUS, PROCESSING CONTROL METHOD, AND MEDIUM

(71) Applicant: NEC Corporation, Tokyo (JP)

(72) Inventors: Junya Kawai, Tokyo (JP); Masahiko Takahashi, Tokyo (JP); Taiga Iyoku, Tokyo (JP); Kosei Kobayashi, Tokyo (JP)

(73) Assignee: NEC Corporation, Tokyo (JP)

(21) Appl. No.: 19/530,715

(22) Filed: Feb. 5, 2026

(30) Foreign Application Priority Data
Mar. 12, 2025 (JP) 2025-039351

(51) Int. Cl. G06N 3/0475; G06F 40/40

(52) U.S. Cl. CPC G06N 3/0475; G06F 40/40

(57) ABSTRACT

A processing control apparatus according to the present disclosure includes: a memory configured to store instructions; and one or more processors configured to execute the instructions to: acquire instruction information to be input to a generative AI system; estimate a response time required to acquire response information related to the instruction information for each of a plurality of generative AI systems; select a generative AI system that acquires the response information related to the instruction information based on the estimated response time; and acquire the response information related to the instruction information from the selected generative AI system by transmitting the instruction information to the selected generative AI system. Accordingly, the present apparatus, method and program enhance efficient decision making when selecting an optimal generative AI system.

This application is based upon and claims the benefit of priority from Japanese Patent Application No. 2025-039351, filed on Mar. 12, 2025, the disclosure of which is incorporated herein in its entirety by reference.

### TECHNICAL FIELD

The present disclosure relates to a processing control apparatus, a processing control method, and a medium for controlling processing for using a generative artificial intelligence (AI) system.

### BACKGROUND ART

JP-T 2024-534316 A discloses a method of a split inference computation of a machine learning model in which time is allocated starting from a machine learning model with a high priority level and a machine learning model with a low priority level is split into sub-models having a duration equal to or less than a remaining period.

### SUMMARY

An object of the present disclosure is to provide a processing control apparatus and the like that appropriately selects and uses a generative AI system that acquires response information from among a plurality of generative AI systems.

A processing control apparatus according to an aspect of the present disclosure includes an instruction information acquisition means for acquiring instruction information to be input to a generative AI system, a response time estimation means for estimating a response time required to acquire response information related to the instruction information for each of a plurality of generative AI systems, an instruction destination selection means for selecting a generative AI system that acquires the response information related to the instruction information based on the estimated response time, and a response information acquisition means for acquiring the response information related to the instruction information from the selected generative AI system by transmitting the instruction information to the selected generative AI system.

A processing control method according to an aspect of the present disclosure includes acquiring instruction information to be input to a generative AI system, estimating a response time required to acquire response information related to the instruction information for each of a plurality of generative AI systems, selecting a generative AI system that acquires the response information related to the instruction information based on the estimated response time, and acquiring the response information related to the instruction information from the selected generative AI system by transmitting the instruction information to the selected generative AI system.

A program according to an aspect of the present disclosure causes a computer to execute processing of acquiring instruction information to be input to a generative AI system, processing of estimating a response time required to acquire response information related to the instruction information for each of a plurality of generative AI systems, processing of selecting a generative AI system that acquires the response information related to the instruction information based on the estimated response time, and processing of acquiring the response information related to the instruction information from the selected generative AI system by transmitting the instruction information to the selected generative AI system.

### BRIEF DESCRIPTION OF THE DRAWINGS

FIG. 1 is a block diagram illustrating an example of a configuration of a processing control apparatus;

FIG. 2 is a block diagram illustrating an example of a configuration of the processing control apparatus including a generation time estimation unit;

FIG. 3 is a block diagram illustrating an example of a configuration of the processing control apparatus including a communication time estimation unit;

FIG. 4 is a diagram for describing selection in an instruction destination selection unit;

FIG. 5 is a block diagram illustrating an example of a configuration of the processing control apparatus including an information determination unit;

FIG. 6 is a block diagram illustrating an example of a configuration of another example of the processing control apparatus including the information determination unit;

FIG. 7 is a block diagram illustrating an example of a configuration of the processing control apparatus including an information storage unit;

FIG. 8 is a flowchart illustrating an example of an operation of the processing control apparatus; and

FIG. 9 is a block diagram illustrating an example of a hardware configuration of the processing control apparatus.

### EXAMPLE EMBODIMENT

An example embodiment of the present disclosure will be described with reference to the drawings. Each drawing is for describing the example embodiment. However, the example embodiment is not limited to those described in the drawings. For example, lines connecting configurations in the drawings are attached to facilitate understanding of the description. Therefore, connection between configurations is not limited to the connection line in the drawings.

### First Example Embodiment

First, a system to be selected will be described. In the following description, a generative AI system will be used as a system that generates response information from instruction information. The generative AI system is a system that generates response information such as text, an image and voice, based on given instruction information such as text, an image and voice, by using a machine learning algorithm, particularly a deep learning model. For example, the generative AI system is a system that is trained by machine learning using a data set of large-scale instruction information and response information that is a correct answer to the instruction information, and is a system that generates response information according to newly given instruction information. Furthermore, in the following description, as an example of the generative AI system, a system that automatically generates multi-modal information including information such as text, an image and voice by using a large language model (LLM) is used for the description. However, the system that generates the response information from the instruction information in the present disclosure is not limited to the generative AI system that generates the response information by using the LLM.

The configuration and position of the generative AI system are not limited. For example, the generative AI system may be provided in a processing control apparatus 10, may be configured as an external individual apparatus, or may be configured as a system using a plurality of computers such as cloud computing. For example, the processing control apparatus 10 may include all the generative AI systems to be selected. Alternatively, the processing control apparatus 10 may include one or more generative AI systems to be selected, and may be connected to an external generative AI system as another generative AI system. Alternatively, all of the plurality of generative AI systems to be selected may be included in apparatus or a system connected to the processing control apparatus 10.

Furthermore, the generative AI system may be configured as software that operates on a computer, or may be configured as a combination of hardware such as a processor for AI and software.

However, in the following description, for convenience of description, it is assumed that the processing control apparatus 10 includes one generative AI system and is further connected to another external generative AI system. In a case where these generative AI systems are distinguished, the generative AI system included in the processing control apparatus 10 is referred to as a first generative AI system, and an external generative AI system is referred to as a second generative AI system.

For example, the first generative AI system is an example of a local generative AI system included in the processing control apparatus 10. On the other hand, the second generative AI system is an example of an external remote generative AI system that is larger in scale than the local generative AI system included in the processing control apparatus 10. The second generative AI system is, for example, a large-scale generative AI system in which communication via an external network is required to exchange information for an external system, but inference performance, accuracy or the like is higher than one of the first generative AI system.

However, the generative AI system to be selected is not limited to the above. For example, the processing control apparatus 10 may use three or more generative AI systems. For example, the processing control apparatus 10 may include one local generative AI system and may be connected to two or more remote generative AI systems. Alternatively, the processing control apparatus 10 may include two or more local generative AI systems and may be connected to one or two or more remote generative AI systems.

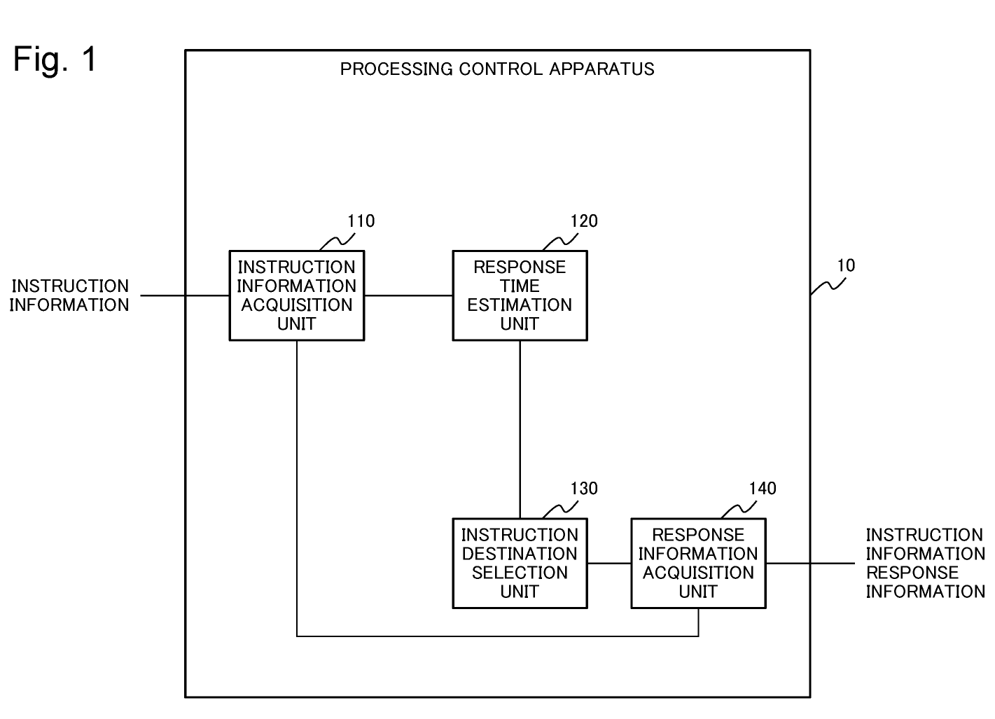

FIG. 1 is a block diagram illustrating an example of a configuration of the processing control apparatus 10. The processing control apparatus 10 includes an instruction information acquisition unit 110, a response time estimation unit 120, an instruction destination selection unit 130, and a response information acquisition unit 140.

The instruction information acquisition unit 110 acquires instruction information to be input to the generative AI system. The instruction information is information input to the generative AI system to acquire a response. The instruction information is, for example, a text input as a prompt to the generative AI system, but is not limited to the text, and may be multi-modal information including a table, an image, voice or the like.

An acquisition source of the instruction information is not limited. For example, the instruction information acquisition unit 110 may acquire the instruction information from a device operated by a user. Alternatively, in a case where the processing control apparatus 10 includes an input apparatus such as a keyboard, a mouse or a touch panel, the instruction information acquisition unit 110 may acquire the instruction information from these input apparatuses. Alternatively, the instruction information acquisition unit 110 may acquire the instruction information stored in a storage device.

The response information is information acquired as a response from the generative AI system to which the instruction information has been input. The response information is not limited to text, and may be multi-modal information including a table, an image, voice or the like. A type of information included in the response information may be the same as or different from a type of information included in the instruction information. For example, in a case where the instruction information is text for instructing generation of an image, the response information may be an image generated based on the text.

The response time estimation unit 120 estimates a response time required to acquire the response information related to the instruction information for each of a plurality of generative AI systems. The response time is a time from when the instruction information is transmitted to when the response information is acquired for each of the plurality of generative AI systems. Generally, the response time varies depending on the instruction information. Furthermore, the response time is different for each of the plurality of generative AI systems. In this regard, the response time estimation unit 120 estimates the response time for each of the plurality of generative AI systems by using the instruction information acquired by the instruction information acquisition unit 110. In the following description, an “estimated response time” may be simply referred to as a “response time”.

A method by which the response time estimation unit 120 estimates the response time is not limited.

For example, the response time estimation unit 120 may use a response time estimation model generated by machine learning using, as training data, past instruction information for each generative AI system and an actual response time until the response information for the instruction information is acquired.

A generation source and a storage position of the response time estimation model are not limited. For example, the response time estimation unit 120 may use a response time estimation model generated in advance by the processing control apparatus 10. Alternatively, the response time estimation unit 120 may acquire and use a response time estimation model generated by another apparatus. For example, the response time estimation unit 120 may acquire a response time estimation model for the second generative AI system, which is an external system, from a system that provides a function of the second generative AI system. Alternatively, the response time estimation unit 120 may transmit the instruction information to another apparatus including a response time estimation model, and acquire a response time estimated by another apparatus as the transmission destination applying the instruction information to the response time estimation model.

Alternatively, the response time estimation unit 120 may estimate the response time by using a response time estimation equation calculated as a result of regression analysis using past instruction information and an actual response time until response information for the instruction information is acquired. Also in this case, the response time estimation unit 120 may acquire a response time estimation equation calculated by another apparatus. For example, the response time estimation unit 120 may acquire a response time estimation equation from a system that provides a function as the second generative AI system. Alternatively, the response time estimation unit 120 may transmit the instruction information to another apparatus including a response time estimation equation and acquire a response time calculated by another apparatus as the transmission destination. However, the method by which the response time estimation unit 120 estimates the response time is not limited to the above.

The response time estimation unit 120 may estimate the response time using a plurality of estimation values. For example, the response time estimation unit 120 may estimate the response time by dividing the response time into a generation time of the response information in each of the plurality of generative AI systems and a communication time required for communication of the instruction information and the response information with each of the plurality of generative AI systems. For example, the processing control apparatus 10 may include at least one of a configuration for estimating the generation time of the response information in each of the plurality of generative AI systems and a configuration for estimating the communication time for communicating the instruction information and the response information with each of the plurality of generative AI systems.

These configurations will be described with reference to the drawings. In the drawings used in the following description, for convenience of description, these configurations are illustrated as configurations different from the response time estimation unit 120. However, at least a part of these configurations may be included in the response time estimation unit 120. That is, these configurations may be included in the response time estimation unit 120 or may be achieved as configurations different from the response time estimation unit 120.

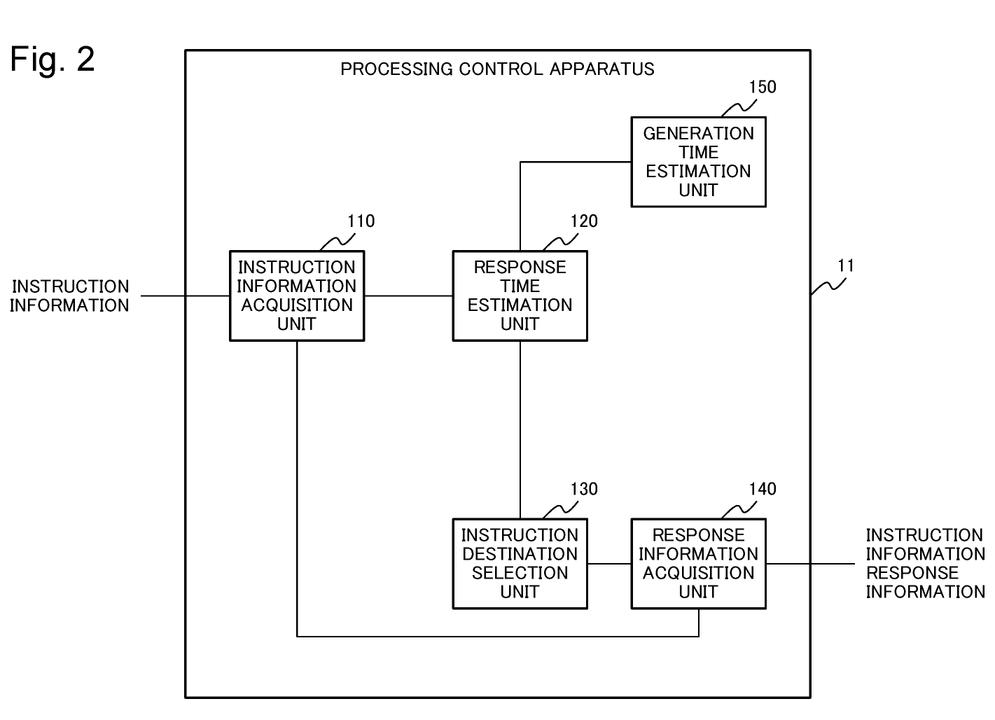

FIG. 2 is a block diagram illustrating an example of a configuration of a processing control apparatus 11 including a generation time estimation unit 150. The processing control apparatus 11 includes the generation time estimation unit 150 in addition to the configuration of the processing control apparatus 10.

The generation time estimation unit 150 estimates the generation time in each of a plurality of generative AI systems by using the characteristic of the instruction information. Then, the response time estimation unit 120 may use the estimated generation time as the response time.

The characteristic of the instruction information is a characteristic that affects the generation time for generating the response information according to the instruction information in each generative AI system. For example, the characteristic of the instruction information is at least one of a size of the instruction information, a degree of complexity of a language structure in the instruction information, a language used and the number of types of information included in the multi-modal information. The degree of complexity of the language structure is, for example, the number of conditions, the number of branches and the number of hierarchies in the instruction information, but not limited thereto. The types of information included in the multi-modal information are, for example, text, a table, an image and voice, but are not limited thereto. Alternatively, the characteristic of the instruction information may be, for example, at least one of the number of languages used, a type of question, whether an output structure is specified, whether there is a negative expression, whether there is a poetic expression and whether there is a technical term. The type of question is, for example, whether an answer can be made with “yes/no”, but is not limited thereto. The specification of the output structure is, for example, in a form of a bulleted list or a table, but is not limited thereto.

However, the characteristic of the instruction information is not limited thereto. For example, the characteristic of the instruction information may include a characteristic of the response information generated according to the instruction information. Similarly to the characteristic of the instruction information, the characteristic of the response information includes, but is not limited to, a processing amount for generating the response information, a size of the response information generated according to the instruction information, the degree of complexity of the language structure, the language used and the number of types of information included, for example.

Furthermore, the characteristic of the instruction information may include a characteristic of reference information used in generating the response information. The characteristic of the reference information may include at least one of whether the reference information is used, the number of pieces of reference information to be used, a size of the reference information and a storage location of the reference information. A method of generating the response information using the reference information is, for example, retrieval-augmented generation (RAG), but is not limited thereto.

A method by which the generation time estimation unit 150 estimates the generation time is not limited. For example, the generation time estimation unit 150 may use a generation time estimation model generated by machine learning using training data as a method of estimating the generation time of the response information using the instruction information. For example, the generation time estimation unit 150 may use a generation time estimation model generated by using machine learning using, as training data, the past instruction information, the characteristic of the instruction information and an actual generation time of the response information for the instruction information in each generative AI system. Alternatively, the generation time estimation unit 150 may estimate the generation time by using a generation time estimation equation calculated from regression analysis using the past instruction information, the characteristic thereof and the actual generation time of the response information.

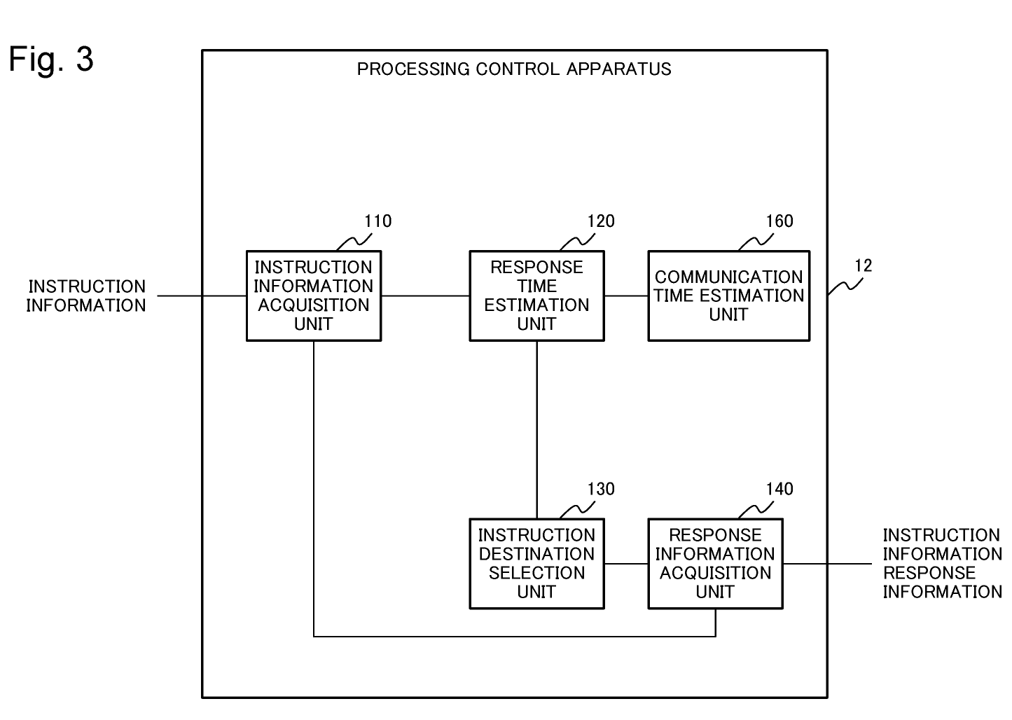

FIG. 3 is a block diagram illustrating an example of a configuration of a processing control apparatus 12 including a communication time estimation unit 160. The processing control apparatus 12 includes the communication time estimation unit 160 in addition to the configuration of the processing control apparatus 10. The processing control apparatus 12 may include the generation time estimation unit 150.

The communication time estimation unit 160 estimates the communication time by using at least one of connection information for each of a plurality of generative AI systems, the size of the instruction information, the size of the response information estimated based on the instruction information and the characteristics of the response information and the instruction information. The characteristics of the response information and the instruction information are, for example, an extent to which the response information and the instruction information share the same characteristic such as the type of information, but are not limited thereto. The response time estimation unit 120 uses the estimated communication time as the response time. In a case where the processing control apparatus 12 includes the generation time estimation unit 150, the response time estimation unit 120 may use the estimated generation time and communication time as the response time. For example, the response time estimation unit 120 may use, as the response time, a total of the estimated generation time and communication time.

The connection information is, for example, information that affects communication performance such as a bandwidth, latency or redundancy for a communication path for connecting to each of a plurality of generative AI systems. For example, the communication time estimation unit 160 may estimate a transmission time of the instruction information and a reception time of the response information from the bandwidth of the communication path, the size of the instruction information and the size of the response information, and may use a total of the estimated transmission time and reception time as an estimation value of the communication time. However, the connection information is not limited thereto, and may be, for example, probabilistic information regarding a communication operation in the communication path such as reliability, stability or availability of the communication path.

A method by which the communication time estimation unit 160 estimates the communication time is not limited. For example, the communication time estimation unit 160 may use a communication time estimation model generated by using machine learning using, as training data, past connection information, the instruction information, the response information and an actual communication time in each generative AI system. Alternatively, the communication time estimation unit 160 may estimate the communication time by using a communication time estimation equation calculated from regression analysis using the past connection information, the instruction information, response information and the actual communication time.

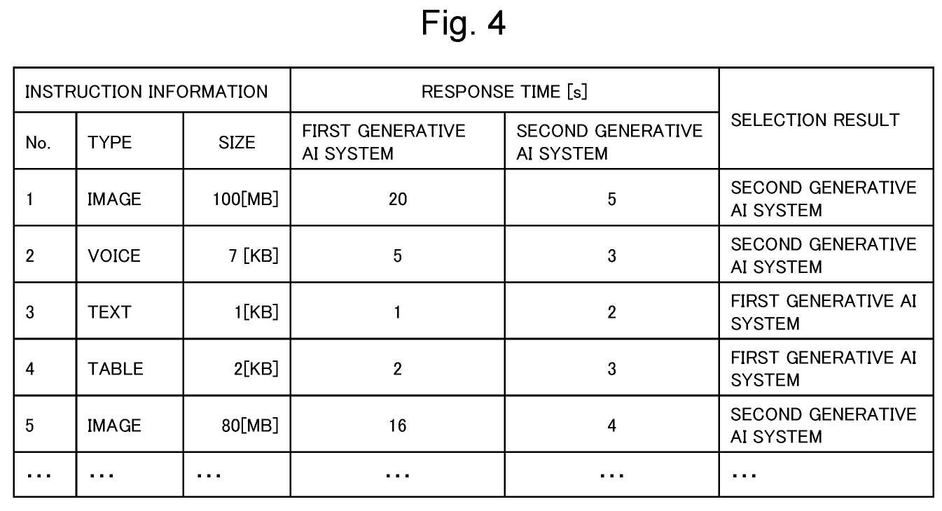

The instruction destination selection unit 130 selects a generative AI system that acquires the response information related to the instruction information, based on the estimated response time. For example, the instruction destination selection unit 130 may select the generative AI system having the shortest estimated response time. FIG. 4 is a diagram for describing selection in the instruction destination selection unit 130. Each row in FIG. 4 indicates, for each piece of the instruction information, an instruction information number, a type and a size of the instruction information, the response time of each generative AI system and a selection result. However, FIG. 4 is not intended to limit the information used for selection to the type and size of the instruction information, and to limit the unit of the response time to second (s).

For example, the instruction information of No. 1 is an image of 100 [MB], the response time of the first generative AI system is 20 [s] and the response time of the second generative AI system is 5 [s]. As described above, in the case of the instruction information of NO. 1, since the response time of the second generative AI system is shorter than the response time of the first generative AI system, the instruction destination selection unit 130 selects the second generative AI system. Alternatively, in the case of the instruction information No. 3, since the response time of the first generative AI system is shorter than the response time of the second generative AI system, the instruction destination selection unit 130 selects the first generative AI system. However, a selection operation in the instruction destination selection unit 130 is not limited to the above.

For example, communication with the second generative AI system, which is an external generative AI system, may be interrupted. For example, in a case where the processing control apparatus 10 is apparatus carried and moved by the user such as a smartphone, a communication state with the second generative AI system changes according to a position of the processing control apparatus 10. On the other hand, since the first generative AI system is mounted on the processing control apparatus 10, a fluctuation in the response time is small. Therefore, in a case where there is little difference in response time between the first generative AI system and the second generative AI system, when the first generative AI system is used, there is a high possibility that the response information can be acquired within a time of about the estimated response time.

In this regard, even in a case where the response time of the first generative AI system is longer than that of the second generative AI system, the instruction destination selection unit 130 may select the first generative AI system in a case where the response time of the first generative AI system is equal to or less than a preset threshold. For example, in a case where the threshold is 5 seconds in FIG. 4, the instruction destination selection unit 130 may select the first generative AI system as an instruction destination of the instruction information of No. 2. As described above, in a case where the response time of the first generative AI system included in the processing control apparatus 10 is equal to or less than the threshold, the instruction destination selection unit 130 may select the first generative AI system included in the processing control apparatus 10.

Alternatively, even in a case where the response time of the first generative AI system is longer than the response time of the second generative AI system, the instruction destination selection unit 130 may select the first generative AI system in a case where a difference in the response time is equal to or less than a preset threshold. For example, in a case where the threshold of the difference in the response time is 2 seconds in FIG. 4, the instruction destination selection unit 130 may select the first generative AI system as the instruction destination of the instruction information of No. 2.

Alternatively, an operation of the generative AI system is an operation with a large load. For example, in a case where the processing control apparatus 10 is a portable moving apparatus such as a smartphone, a capacity of the mounted storage battery is limited. Therefore, in a case where there is little difference in response time between the first generative AI system and the second generative AI system, it is assumed that it is better to select the second generative AI system in consideration of consumption of the storage battery. In this regard, even in a case where the response time of the first generative AI system is shorter than the response time of the second generative AI system, the instruction destination selection unit 130 may select the second generative AI system in a case where the response time of the first generative AI system is equal to or more than the preset threshold. Alternatively, even in a case where the response time of the first generative AI system is shorter than the response time of the second generative AI system, the instruction destination selection unit 130 may select the second generative AI system in a case where the difference in the response time is equal to or less than the preset threshold. For example, in a case where the threshold of the difference in the response time is 1 second in FIG. 4, the instruction destination selection unit 130 may select the second generative AI system as the instruction destination of the instruction information of No. 4.

In this manner, the instruction destination selection unit 130 may select the generative AI system by using the threshold set for the estimated response time.

Alternatively, the instruction destination selection unit 130 may execute a normal operation in a case where a remaining capacity of the storage battery mounted on the processing control apparatus 10 is large, and execute an operation in consideration of consumption of the storage battery in a case where the remaining capacity is equal to or less than a threshold. In this manner, the instruction destination selection unit 130 may change the operation of selecting the generative AI system, based on the remaining capacity of the storage battery mounted in the processing control apparatus 10.

The instruction information may include sensitive personal information such as medical information, confidential information of a company such as business information or information that needs to be avoided from being leaked to the outside, such as legally protected information. In a case where such information is included, it is desirable to avoid using a generative AI system outside the processing control apparatus 10. In this regard, the instruction destination selection unit 130 may select the generative AI system based on the information included in the instruction information.

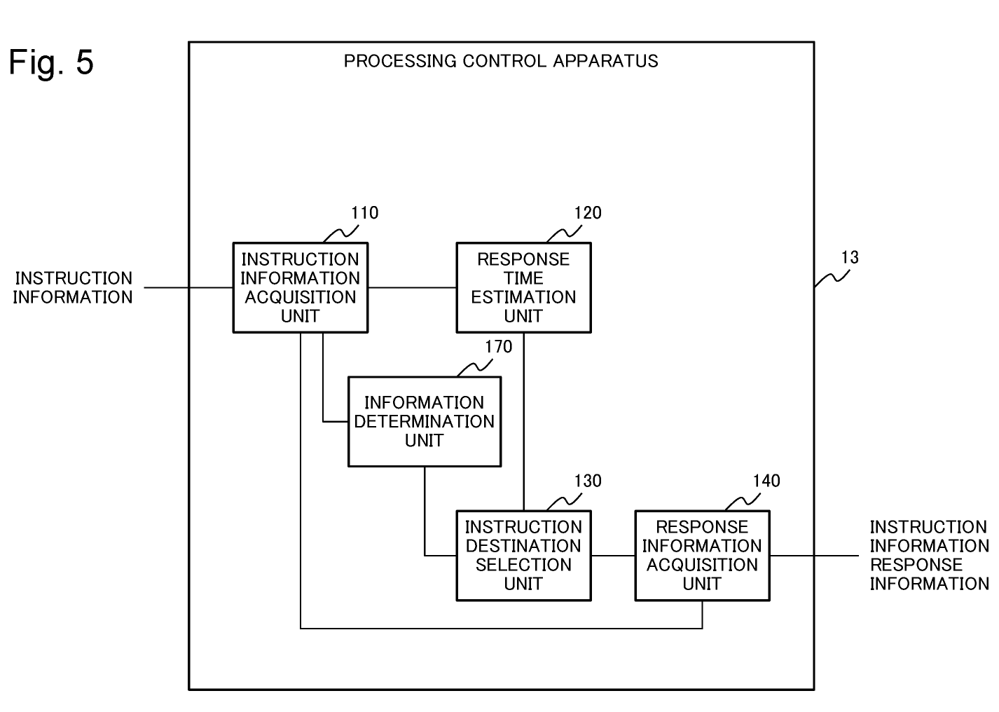

FIG. 5 is a block diagram illustrating an example of a configuration of a processing control apparatus 13 including an information determination unit 170. The processing control apparatus 13 includes the information determination unit 170 in addition to the configuration of the processing control apparatus 10. The processing control apparatus 13 may include at least one of the generation time estimation unit 150 and the communication time estimation unit 160.

The information determination unit 170 determines whether the instruction information includes information that is not allowed to be output to the outside of the processing control apparatus 10. For example, the information determination unit 170 determines whether the instruction information includes at least one of the sensitive personal information, the confidential information of a company and the legally protected information. Then, in a case where the instruction information includes information that is not allowed to be output to the outside of the processing control apparatus 10, the instruction destination selection unit 130 selects the first generative AI system included in the processing control apparatus 10. In a case where the instruction information includes information that is not allowed to be output to the outside and the processing control apparatus 10 does not include the generative AI system, the instruction destination selection unit 130 cannot execute an operation using the generative AI system. In this regard, in such a case, the instruction destination selection unit 130 may display or output information indicating that the instruction information includes information that is not allowed to be output to the outside.

The sensitive personal information is, for example, at least one of medical information, financial information and preference information of an individual, but is not limited thereto. The confidential information of a company is, for example, at least one of financial information, business information and customer information, but is not limited thereto. The legally protected information is, for example, at least one of information acquired from a customer, contractual confidential information and national information such as defense-related information, but is not limited thereto.

The company information may be ranked according to a degree of importance or the like. For example, there is a case where the financial information of a company is managed by being divided into a plurality of ranks, ranging from publicly disclosed information to information disclosed within a management team. In this regard, the information determination unit 170 may determine whether the information included in the instruction information is information that is not allowed to be output to the outside of the processing control apparatus 10, by using a rank such as the degree of importance or a degree of necessity of confidentiality set in the information included in the instruction information. For example, in a case where the instruction information includes information having a predetermined rank, the information determination unit 170 may determine that the instruction information includes information that is not allowed to be output to the outside. The predetermined rank is, for example, the highest rank, but is not limited thereto.

The communication path with the generative AI system is not limited to a communication path with an unknown user and path such as the Internet, and there is a communication path with high security such as a dedicated line. In this regard, even in a case where the instruction information includes information that is not allowed to be output to the outside of the processing control apparatus 10, when the security of a communication path with the generative AI system is high, the instruction destination selection unit 130 may select the generative AI system to communicate via the communication path. As described above, the instruction destination selection unit 130 may select the generative AI system by using the information that is not allowed to be output to the outside included in the instruction information and the security in the communication path with each generative AI system. Also in this case, the instruction destination selection unit 130 may use a rank of the information included in the instruction information.

Alternatively, in a case where the instruction information is short, in particular, in a case where the instruction information is short in text, the response time is estimated to be short regardless of which generative AI system is used. In such a case, it is less necessary to use the external second generative AI system. In this regard, the information determination unit 170 may determine an information amount such as the number of characters in the instruction information. Then, in a case where the information amount such as the number of characters in the instruction information is equal to or less than a threshold, the instruction destination selection unit 130 may select the first generative AI system.

In a case where the instruction destination selection unit 130 selects the first generative AI system based on a determination result of the information determination unit 170, in particular, in a case where the processing control apparatus 13 includes one generative AI system, the response time estimation unit 120 may not operate. In this regard, the processing control apparatus 13 may be configured in such a way that the information determination unit 170 determines that information that is not allowed to be output to the outside of the processing control apparatus 10 is not included in the instruction information, and then another configuration operates.

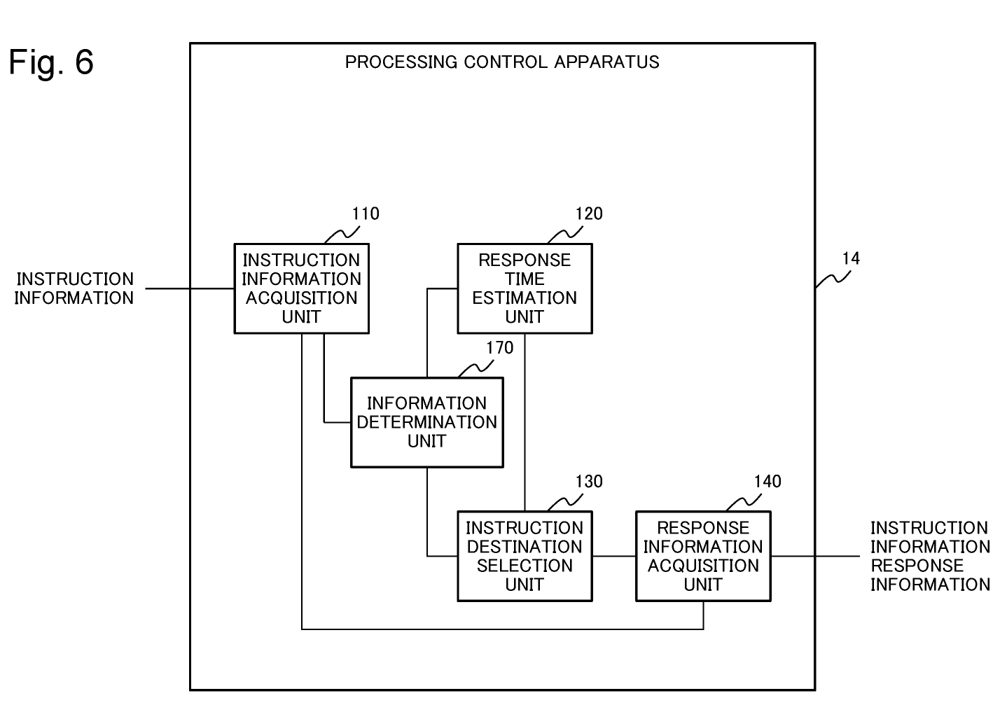

FIG. 6 is a block diagram illustrating an example of a configuration of a processing control apparatus 14 that is another example of the processing control apparatus 13 including the information determination unit 170. The processing control apparatus 14 may also include at least one of the generation time estimation unit 150 and the communication time estimation unit 160. In FIG. 6, the information determination unit 170 determines whether the instruction information includes information that is not allowed to be output to the outside of the processing control apparatus 10. In a case where it is determined that the instruction information does not include information that is not allowed to be output to the outside of the processing control apparatus 10, the information determination unit 170 outputs the instruction information to the response time estimation unit 120. In this case, the configuration such as the response time estimation unit 120 operates similarly to the above description.

On the other hand, in a case where it is determined that the instruction information includes information that is not allowed to be output to the outside of the processing control apparatus 10, the information determination unit 170 outputs the determination result and the instruction information to the instruction destination selection unit 130. The instruction destination selection unit 130 selects, as an instruction destination, the first generative AI system based on the determination result. In this case, the response time estimation unit 120 may not operate. Therefore, in a case where a proportion of the instruction information including the information that is not allowed to be output to the outside of the processing control apparatus 10 is high, the processing control apparatus 10 can reduce power consumption due to the operation of the response time estimation unit 120.

As described above, the information determination unit 170 may first acquire the instruction information from the instruction information acquisition unit 110 and determine whether the instruction information includes information that is not allowed to be output to the outside of the processing control apparatus 10. Then, the information determination unit 170 may output the instruction information to either the response time estimation unit 120 or the instruction destination selection unit 130 based on a determination result.

In a case where the processing control apparatus 14 includes a plurality of generative AI systems, the instruction destination selection unit 130 may operate by outputting the instruction information to the response time estimation unit 120 and using the response time of each generative AI system included in the processing control apparatus 10 as estimated by the response time estimation unit 120.

Also in the processing control apparatus 14, the information determination unit 170 may determine whether the information amount such as the number of characters in the instruction information is equal to or less than the threshold, and in a case where it is determined that the information amount is equal to or less than the threshold, output a determination result and the instruction information to the instruction destination selection unit 130.

The response information acquisition unit 140 acquires, by transmitting the instruction information to the selected generative AI system, response information related to the instruction information from the generative AI system. A method by which the response information acquisition unit 140 exchanges the instruction information and the response information with the generative AI system is not particularly limited, and may be, for example, the same method as a method of exchanging the instruction information and the like with a general generative AI system. Therefore, a detailed description of the method by which the response information acquisition unit 140 exchanges information with the generative AI system will be omitted.

An output destination of the response information acquired from the generative AI system by the response information acquisition unit 140 is not limited. For example, in a case where the instruction information is acquired from the device operated by the user, the response information acquisition unit 140 may output the response information to the device operated by the user. Alternatively, in a case where the processing control apparatus 10 includes a display device such as a liquid crystal display or a touch panel, the response information acquisition unit 140 may output the response information to the display device to display the response information. In this case, the response information acquisition unit 140 may display the response information in association with the instruction information. Alternatively, the response information acquisition unit 140 may store the response information in the storage device. Also in this case, the response information acquisition unit 140 may store the response information in the storage apparatus in association with the instruction information. Furthermore, the response information acquisition unit 140 may output at least one of the response time estimated by the response time estimation unit 120 and the information indicating the generative AI system selected by the instruction destination selection unit 130 in association with the instruction information and the response information.

In a case where the generative AI system is used, the input of the instruction information may be performed not only once but also a plurality of times. Then, in general, the content of the instruction information is different every time. Therefore, the instruction destination selection unit 130 may select, as a generative AI system to be selected for the latest instruction information, a generative AI system different from the generative AI system selected for the previous instruction information. In such a case, the newly selected generative AI system has not received at least part of the instruction information acquired so far by the instruction information acquisition unit 110. In general, the generative AI system can generate the response information by using the instruction information up to a certain time ago. In this regard, in order to generate more appropriate response information, it is desirable to transmit at least part of the instruction information up to the previous time to the newly selected generative AI system in addition to the instruction information acquired this time. Next, the processing control apparatus 15 for handling such a case will be described.

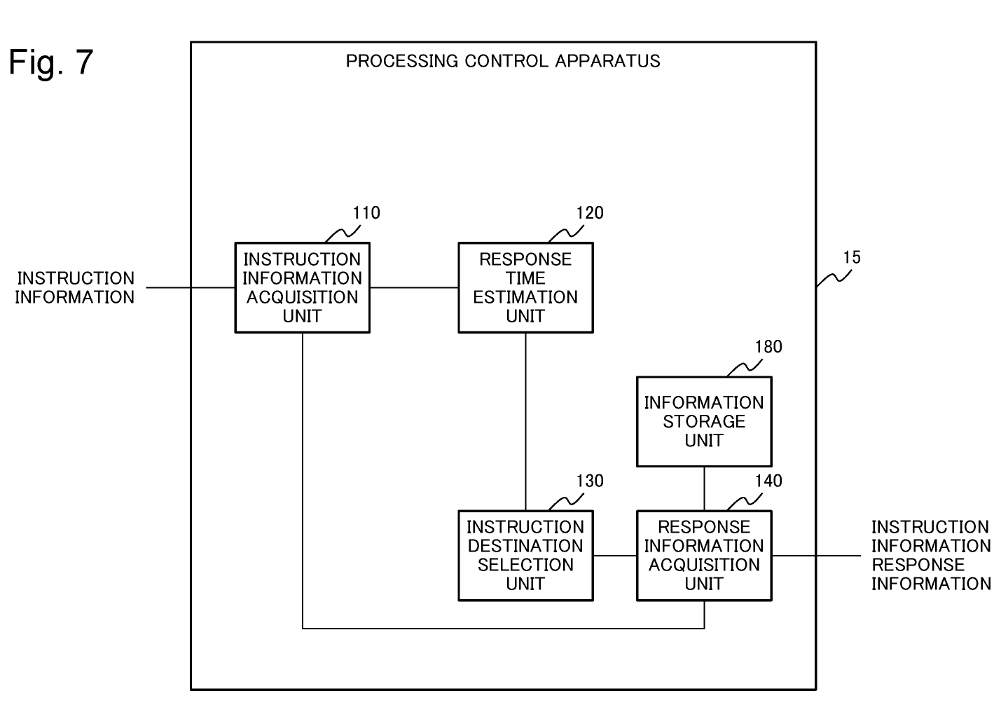

FIG. 7 is a block diagram illustrating an example of a configuration of a processing control apparatus 15 including an information storage unit 180. The processing control apparatus 15 includes the information storage unit 180 in addition to the configuration of the processing control apparatus 10. The processing control apparatus 15 may include at least one of the generation time estimation unit 150, the communication time estimation unit 160 and the information determination unit 170.

The information storage unit 180 stores the instruction information transmitted to the generative AI system by the response information acquisition unit 140. Then, in a case where the instruction destination selection unit 130 selects a generative AI system different from a previously selected generative AI system, the response information acquisition unit 140 transmits, to the newly selected generative AI system, at least part of the instruction information stored in the information storage unit 180, and the instruction information acquired this time by the instruction information acquisition unit 110. The response information acquisition unit 140 may transmit all the instruction information stored in the information storage unit 180 to the generative AI system.

However, some generative AI systems operate using a certain limited number or range of instruction information, starting from the most recent, in the past instruction information. In a case where the number of times of exchange with the generative AI system is large, when all the instruction information is transmitted, the transmission time becomes long. In this regard, the response information acquisition unit 140 may transmit, to the generative AI system, a predetermined number of pieces of or a predetermined range of instruction information, starting from the most recent, in the instruction information stored in the information storage unit 180. The predetermined number is, for example, 10 from the most recent, but is not limited thereto. The predetermined range is, for example, instruction information up to 10 times before the instruction information transmitted immediately before, but is not limited thereto. The response information acquisition unit 140 may change the number of pieces of or range of the instruction information to be transmitted, according to the generative AI system as the transmission destination of the instruction information.

In a case where the newly selected generative AI system is not the previously selected generative AI system, but is a generative AI system that has been selected before, the generative AI system has already acquired the instruction information when the generative AI system was selected before. In a case where such a generative AI system that has been selected before is selected again, the response information acquisition unit 140 may not transmit the instruction information transmitted in the past. For example, in a case where the generative AI system that has been selected before is selected again, the response information acquisition unit 140 may transmit, to the generative AI system selected again, the instruction information transmitted to another generative AI system after the instruction information transmitted last to the generative AI system selected again.

In order to achieve the above operation, for example, the information storage unit 180 may store information regarding the generative AI system that has transmitted the instruction information, in addition to the instruction information and the response information. The information regarding the generative AI system in this case is, for example, information indicating an identifier, a name or a location for distinguishing the generative AI system. The generative AI system as the transmission destination of the instruction information is a generation location of the response information. That is, the information regarding the generative AI system is also information regarding the generation location of the response information. Then, the response information acquisition unit 140 determines the generative AI system as the transmission destination of the stored instruction information, by using the identifier of the generative AI system or the like stored in association with the instruction information. Then, the response information acquisition unit 140 may determine whether the stored instruction information is the instruction information already transmitted to the selected generative AI system, select and transmit the instruction information to be transmitted to the generative AI system selected again, from the stored instruction information, and transmit the instruction information.

The newly selected generative AI system is not limited to the past instruction information, and may be able to refer to other information. For example, the newly selected generative AI system can refer to the response information of the generative AI system selected in the past. In this regard, the information storage unit 180 may store the response information acquired from the generative AI system by the response information acquisition unit 140 in association with the instruction information. Then, the response information acquisition unit 140 may transmit, to the newly selected generative AI system, the response information associated with at least part of the instruction information to be transmitted to the newly selected generative AI system. In this case, the response information acquisition unit 140 may transmit all pieces of response information associated with the instruction information, or may transmit some pieces of response information such as a predetermined number of pieces of response information from the most recent. The predetermined number is, for example, 10 pieces of response information from the most recent, but is not limited thereto.

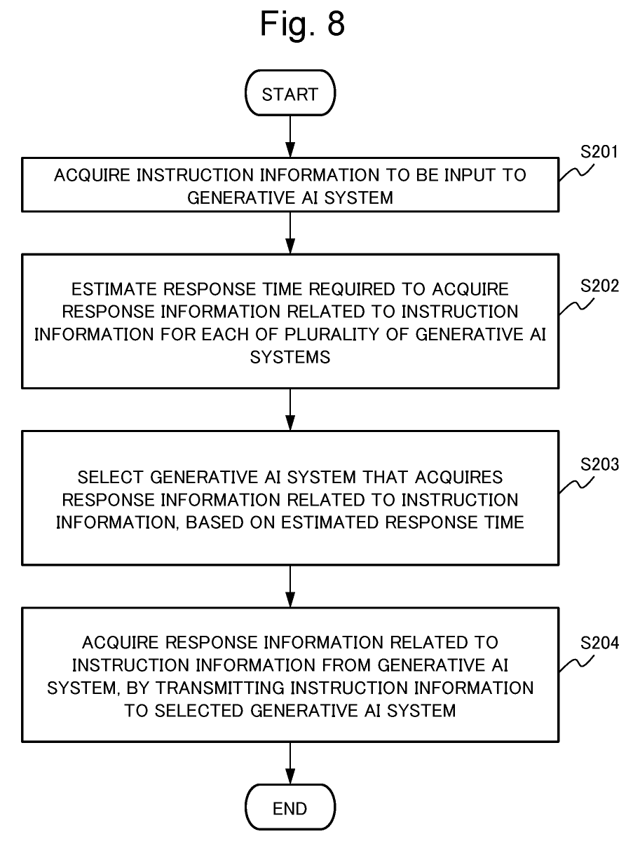

FIG. 8 is a flowchart illustrating an example of an operation of the processing control apparatus 10. The instruction information acquisition unit 110 acquires instruction information to be input to the generative AI system (step S201). The response time estimation unit 120 estimates a response time required to acquire the response information related to the instruction information for each of a plurality of generative AI systems (step S202). For example, the response time estimation unit 120 may use, as the response time, a generation time estimated by the generation time estimation unit 150. Alternatively, the response time estimation unit 120 may use, as the response time, a communication time estimated by the communication time estimation unit 160. The response time estimation unit 120 may use the generation time and the communication time as the response time.

The instruction destination selection unit 130 selects a generative AI system that acquires the response information related to the instruction information, based on the estimated response time (step S203). The instruction destination selection unit 130 may select the generative AI system based on a determination result as to whether the instruction information by the information determination unit 170 includes information that is not allowed to be output to the outside of the processing control apparatus 10. The response information acquisition unit 140 acquires response information related to the instruction information from the generative AI system, by transmitting the instruction information to the selected generative AI system (step S204). In a case where a generative AI system different from the generative AI system previously selected by the instruction destination selection unit 130 is selected, the response information acquisition unit 140 may transmit, to the newly selected generative AI system, at least part of information such as the instruction information stored in the information storage unit 180.

As described above, the processing control apparatus 10 includes the instruction information acquisition unit 110, the response time estimation unit 120, the instruction destination selection unit 130, and the response information acquisition unit 140. The instruction information acquisition unit 110 acquires instruction information to be input to the generative AI system. The response time estimation unit 120 estimates a response time required to acquire the response information related to the instruction information for each of a plurality of generative AI systems. The instruction destination selection unit 130 selects a generative AI system that acquires the response information related to the instruction information, based on the estimated response time. The response information acquisition unit 140 acquires response information related to the instruction information from the generative AI system, by transmitting the instruction information to the selected generative AI system.

The instruction destination selection unit 130 selects a generative AI system that acquires the response information related to the instruction information, based on the response time estimated by the response time estimation unit 120. That is, the instruction destination selection unit 130 selects an appropriate generative AI system from among a plurality of generative AI systems, by using the estimated response time. Then, the response information acquisition unit 140 acquires the response information related to the instruction information from the generative AI system selected in this manner. Therefore, the processing control apparatus 10 can appropriately select the generative AI system that acquires the response information, from among the plurality of generative AI systems, and use the generative AI system.

In a case where a plurality of generative AI systems can be used, it is desirable to select and use an appropriate generative AI system. For example, a response time from transmission of instruction information to the generative AI system to acquisition of response information varies depending on the instruction information, the response information, the generative AI system to be used or the like. In this regard, for example, it is desirable to select and use an appropriate generative AI system from among a plurality of generative AI systems in consideration of the response time until acquisition of the response information.

As described above, according to the present disclosure, it is possible to achieve an effect of appropriately selecting and using a generative AI system that acquires response information from among a plurality of generative AI systems. That is, the processing control apparatus 10 can appropriately select the generative AI system that acquires the response information, from among the plurality of generative AI systems, and use the generative AI system

The response time estimation unit 120 may use, as the response time, a generation time estimated by the generation time estimation unit 150 using instruction information or the like. In this case, the response time estimation unit 120 can estimate a more appropriate response time by using the generation time estimated by the generation time estimation unit 150 using the instruction information or the like. As a result, the instruction destination selection unit 130 can select a more appropriate generative AI system.

The response time estimation unit 120 may use, as the response time, a communication time estimated by the communication time estimation unit 160 using connection information or the like. In this case, the response time estimation unit 120 can estimate a more appropriate response time by using the communication time estimated by the communication time estimation unit 160 using the connection information or the like. As a result, the instruction destination selection unit 130 can select a more appropriate generative AI system.

The instruction destination selection unit 130 may select the generative AI system based on a determination result as to whether the instruction information by the information determination unit 170 includes information that is not allowed to be output to the outside of the processing control apparatus 10. In this case, the response information acquisition unit 140 can prevent leakage of information that is not allowed to be output to the outside, such as sensitive personal information.

In a case where the instruction destination selection unit 130 selects a generative AI system different from the generative AI system previously selected, the response information acquisition unit 140 may transmit, to the newly selected generative AI system, at least part of information such as the instruction information stored in the information storage unit 180. In this case, even when the generative AI system is changed, the response information acquisition unit 140 can acquire more appropriate response information from the newly selected generative AI system.

The processing control apparatus 10 may output and display not only the response information but also other information. For example, the processing control apparatus 10 may output the response time estimated by the response time estimation unit 120 to the device operated by the user or the like to display the response time. In this case, the processing control apparatus 10 may display at least one of the generation time and the communication time constituting the response time. Furthermore, the processing control apparatus 10 may display at least one of the characteristic and the connection information of the instruction information used to estimate the generation time.

Alternatively, in a case where the response time satisfies a condition that affects selection of the generative AI system, such as a case where the response time is equal to or less than a preset threshold, the processing control apparatus 10 may display the estimated response time and information indicating the condition used for the selection such as the threshold. Alternatively, also in a case where information other than the response time such as a processing load or the capacity of the storage battery has been used for the selection, the processing control apparatus 10 may display the information.

Alternatively, in a case where the first generative AI system included in the processing control apparatus 10 is selected since the instruction information includes information that is not allowed to be output to the outside of the processing control apparatus 10, the processing control apparatus 10 may display information indicating that the instruction information includes information that is not allowed to be output to the outside. Furthermore, the processing control apparatus 10 may display information indicating that the first generative AI system included in the processing control apparatus 10 has been used since the instruction information includes information that is not allowed to be output to the outside.

In a case where the instruction information includes information that is not allowed to be output to the outside and the processing control apparatus 10 does not include the generative AI system therein, the processing control apparatus 10 cannot acquire the response information. In this regard, in such a case, the processing control apparatus 10 may display information indicating that the response information cannot be acquired since the instruction information includes information that is not allowed to be output to the outside. Furthermore, the processing control apparatus 10 may display information indicating that the generative AI system is not provided inside the apparatus.

The processing control apparatus 10 may display the above information in association with the display of at least one of the instruction information and the response information, or may display the above information as a display different from the display of at least one of the instruction information and the response information.

### Hardware Configuration

Next, a hardware configuration of the processing control apparatus 10 to 15 will be described. Each configuration of the processing control apparatus 10 to 15 may be configured by hardware circuits. Alternatively, in the processing control apparatus 10 to 15, each component may be configured using a plurality of apparatus that are connected via a network. For example, the processing control apparatus 10 to 15 may be configured using cloud computing. Alternatively, in the processing control apparatus 10 to 15, a plurality of configurations may be configured by one piece of hardware. Alternatively, the processing control apparatus 10 to 15 may be configured using a computer including a processor and a memory. The processor is, for example, but not limited to, a central processing unit (CPU). The memory is, for example, a read-only memory (ROM) and a random access memory (RAM), but not limited thereto. The computer may further include a network interface.

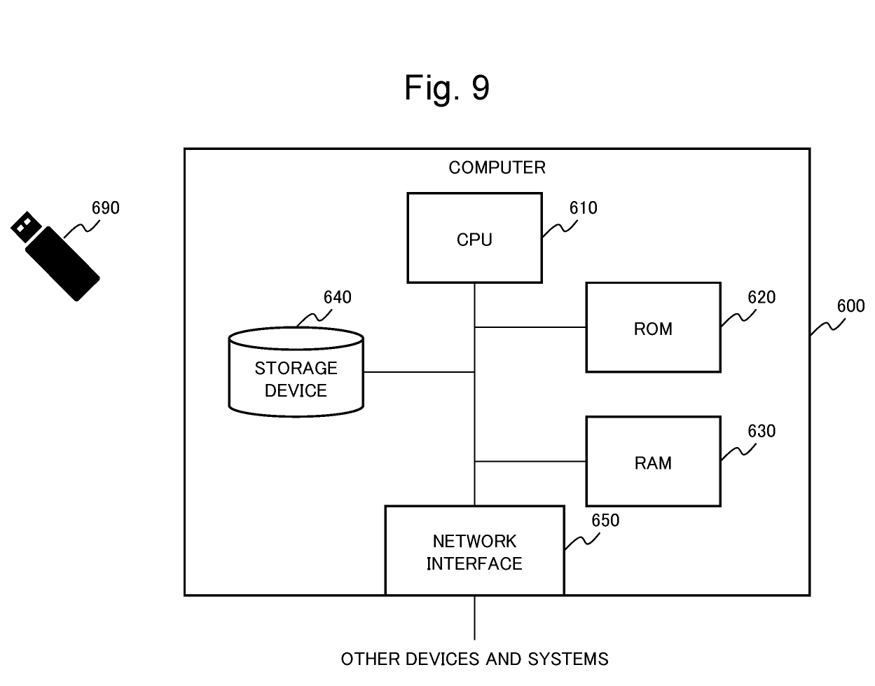

FIG. 9 is a block diagram illustrating an example of a configuration of a computer 600 that is an example of a hardware configuration of the processing control apparatus 10 to 15. The computer 600 may be configured using a virtual machine (VM) that virtually achieves these configurations using software. The computer 600 includes a CPU 610, a ROM 620, a RAM 630, a storage device 640 and a network interface 650.

The CPU 610 reads a program from at least one of the ROM 620 and the storage device 640. Then, the CPU 610 controls the RAM 630, the storage device 640 and the network interface 650 based on the read program. Then, the CPU 610 implements functions as the instruction information acquisition unit 110, the response time estimation unit 120, the instruction destination selection unit 130, the response information acquisition unit 140, the generation time estimation unit 150, the communication time estimation unit 160, the information determination unit 170 and the information storage unit 180. As described above, the computer 600 may implement the functions as combinations of hardware and software.

The CPU 610 may read a program included in a recording medium 690 that stores computer-readable programs, using a recording medium reading device (not illustrated). Alternatively, the CPU 610 may receive a program from an external device (not illustrated) via the network interface 650, store the program in the RAM 630 or the storage device 640, and operate based on the stored program.

The ROM 620 stores the programs executed by the CPU 610 and fixed data. The ROM 620 is, for example, a programmable ROM (P-ROM) or a flash ROM. The RAM 630 temporarily stores the program executed by the CPU 610 and data. The RAM 630 is, for example, a dynamic RAM (D-RAM).

The storage device 640 stores the data and programs to be stored for a long time by the computer 600. The storage device 640 may operate as a temporary storage device of the CPU 610. The storage device 640 is, for example, a hard disk device, a magneto-optical disk device, a solid state drive (SSD) or a disk array device.

The ROM 620 and the storage device 640 are non-transitory recording media. On the other hand, the RAM 630 is a transitory recording medium. Then, the CPU 610 can operate based on the programs stored in the ROM 620, the storage device 640 and the RAM 630. That is, the CPU 610 can also operate using the program stored in either the non-transitory recording medium or the transitory recording medium. When implementing each function, the CPU 610 may use at least one of the RAM 630 and the storage device 640 as a temporary recording medium for programs and data.

The network interface 650 relays information exchange with other devices and systems via a network. For example, the network interface 650 relays information exchange with the device operated by the user that transmits instruction information and receives response information, and the generative AI system. The network interface 650 is, for example, a local area network (LAN) card. Furthermore, the network interface 650 is not limited to wired communication, and may be wireless communication.

The computer 600 configured in this manner implements functions of the processing control apparatus 10 to 15 by executing the operations of the components in the processing control apparatus 10 to 15.

Some or all of the above example embodiments can also be described as the following Supplementary Notes, but are not limited to the following.

### Supplementary Note 1

A processing control apparatus including:
an instruction information acquisition means for acquiring instruction information to be input to a generative AI system;
a response time estimation means for estimating a response time required to acquire response information related to the instruction information for each of a plurality of generative AI systems;
an instruction destination selection means for selecting a generative AI system that acquires the response information related to the instruction information based on the estimated response time; and
a response information acquisition means for acquiring the response information related to the instruction information from the selected generative AI system by transmitting the instruction information to the selected generative AI system.

### Supplementary Note 2

The processing control apparatus according to supplementary note 1, in which
the response time includes at least one of a generation time of the response information in each of a plurality of generative AI systems and a communication time for communicating the instruction information and the response information with each of the plurality of generative AI systems.

### Supplementary Note 3

The processing control apparatus according to supplementary note 2, further including:
a generation time estimation means for estimating the generation time in each of a plurality of generative AI systems by using a characteristic of the instruction information.

### Supplementary Note 4

The processing control apparatus according to supplementary note 3, in which
the characteristic of the instruction information includes at least one of a size of the instruction information, a degree of complexity of a language structure, a language used, a number of types of information included, the number of languages used, a type of question, whether an output structure is specified, whether there is a negative expression, whether there is a poetic expression and whether there is a technical term.

### Supplementary Note 5

The processing control apparatus according to supplementary note 4, in which
the characteristic of the instruction information includes a characteristic of the response information generated according to the instruction information.

### Supplementary Note 6

The processing control apparatus according to supplementary note 5, in which
the characteristic of the response information includes at least one of a processing amount for generating the response information, a size of the response information, a degree of complexity of a language structure, a language used and the number of types of information included.

### Supplementary Note 7

The processing control apparatus according to any one of supplementary notes 4 to 6, in which
the characteristic of the instruction information includes a characteristic of reference information used to generate the response information.

### Supplementary Note 8

The processing control apparatus according to supplementary note 7, in which
the characteristic of the reference information includes at least one of whether the reference information to be used to generate the response information is used, the number of pieces of the reference information, a size of the reference information and a storage location of the reference information.

### Supplementary Note 9

The processing control apparatus according to any one of supplementary notes 2 to 8, further including:
a communication time estimation means for estimating the communication time by using at least one of connection information for each of a plurality of generative AI systems, a size of the instruction information, a size of the response information estimated based on the instruction information and characteristics of the response information and the instruction information.

### Supplementary Note 10

The processing control apparatus according to supplementary note 9, in which
the connection information for each of the plurality of generative AI systems includes at least one of a bandwidth, latency, redundancy, reliability, stability and availability for a communication path for connecting to each of the plurality of generative AI systems.

### Supplementary Note 11

The processing control apparatus according to any one of supplementary notes 1 to 10, further including:
an information storage means for storing the instruction information transmitted to a generative AI system, in which
in a case where the instruction destination selection means selects a generative AI system different from a generative AI system previously selected, the response information acquisition means transmits, to a newly selected generative AI system, at least part of the instruction information stored in the information storage means, and the instruction information acquired this time by the instruction information acquisition means.

### Supplementary Note 12

The processing control apparatus according to supplementary note 11, in which
the information storage means stores the response information acquired from a generative AI system in association with the instruction information, and
the response information acquisition means transmits, to a newly selected generative AI system, the response information associated with at least part of the instruction information to be transmitted to the newly selected generative AI system.

### Supplementary Note 13

The processing control apparatus according to any one of supplementary notes 1 to 12, further including:
an information determination means for determining whether the instruction information includes information that is not allowed to be output to outside of the processing control apparatus, in which
in a case where the instruction information includes the information that is not allowed to be output to the outside of the processing control apparatus, the instruction destination selection means selects a generative AI system included in the processing control apparatus.

### Supplementary Note 14

The processing control apparatus according to supplementary note 13, in which
the information that is not allowed to be output to the outside of the processing control apparatus is at least one of sensitive personal information, confidential information of a company and legally protected information.

### Supplementary Note 15

The processing control apparatus according to supplementary note 13 or 14, in which
the instruction destination selection means selects a generative AI system by using the information that is not allowed to be output to the outside included in the instruction information and security in a communication path with each generative AI system.

### Supplementary Note 16

The processing control apparatus according to any one of supplementary notes 1 to 15, in which
the instruction destination selection means selects a generative AI system by using a threshold set for the estimated response time.

### Supplementary Note 17

The processing control apparatus according to supplementary note 16, in which
the instruction destination selection means selects a generative AI system included in the processing control apparatus in a case where the response time estimated for the generative AI system included in the processing control apparatus is equal to or less than a set threshold.

### Supplementary Note 18

The processing control apparatus according to any one of supplementary notes 1 to 17, in which
the instruction destination selection means changes an operation of selecting a generative AI system, based on a remaining capacity of a storage battery mounted on the processing control apparatus.

### Supplementary Note 19

A processing control method including:
acquiring instruction information to be input to a generative AI system;
estimating a response time required to acquire response information related to the instruction information for each of a plurality of generative AI systems;
selecting a generative AI system that acquires the response information related to the instruction information based on the estimated response time; and
acquiring the response information related to the instruction information from the selected generative AI system by transmitting the instruction information to the selected generative AI system.

### Supplementary Note 20

A program for causing a computer to execute:
processing of acquiring instruction information to be input to a generative AI system;
processing of estimating a response time required to acquire response information related to the instruction information for each of a plurality of generative AI systems;
processing of selecting a generative AI system that acquires the response information related to the instruction information based on the estimated response time; and
processing of acquiring the response information related to the instruction information from the selected generative AI system by transmitting the instruction information to the selected generative AI system.

Some or all of the configurations described in Supplementary Notes 2 to 18 dependent on the above-described Supplementary Note 1 can also be dependent on Supplementary Notes 19 and 20 by the same dependency relationship as in Supplementary Notes 2 to 18. Some or all of the configurations described as Supplementary Notes can be similarly dependent on not only Supplementary Notes 1, 19 and 20, but also diverse pieces of hardware and software, various recording means for recording software or systems without departing from the above-described example embodiments.

While the present invention has been particularly shown and described with reference to example embodiments thereof, the present invention is not limited to these example embodiments. It will be understood by those of ordinary skill in the art that various changes in form and details may be made therein without departing from the spirit and scope of the invention of the present application as defined by the claims.

1. A processing control apparatus comprising:
a memory configured to store instructions; and
one or more processors configured to execute the instructions to:
acquire instruction information to be input to a generative AI system;
estimate a response time required to acquire response information related to the instruction information for each of a plurality of generative AI systems;
select a generative AI system that acquires the response information related to the instruction information based on the estimated response time; and
acquire the response information related to the instruction information from the selected generative AI system by transmitting the instruction information to the selected generative AI system.

2. The processing control apparatus according to claim 1, wherein
the response time includes at least one of a generation time of the response information in each of a plurality of generative AI systems and a communication time for communicating the instruction information and the response information with each of the plurality of generative AI systems.

3. The processing control apparatus according to claim 2, wherein
the one or more processors are further configured to execute the instructions to: estimate the generation time in each of a plurality of generative AI systems by using a characteristic of the instruction information.

4. The processing control apparatus according to claim 3, wherein
the characteristic of the instruction information includes at least one of a size of the instruction information, a degree of complexity of a language structure, a language used, a number of types of information included, the number of languages used, a type of question, whether an output structure is specified, whether there is a negative expression, whether there is a poetic expression and whether there is a technical term.

5. The processing control apparatus according to claim 2, wherein
the one or more processors are further configured to execute the instructions to: estimate the communication time by using at least one of connection information for each of a plurality of generative AI systems, a size of the instruction information, a size of the response information estimated based on the instruction information and characteristics of the response information and the instruction information.

6. The processing control apparatus according to claim 1, wherein
the one or more processors are further configured to execute the instructions to: store the instruction information transmitted to a generative AI system; and
in a case where selecting a generative AI system different from a generative AI system previously selected, transmit, to a newly selected generative AI system, at least part of the stored instruction information, and the instruction information acquired this time.

7. The processing control apparatus according to claim 1, wherein
the one or more processors are further configured to execute the instructions to: determine whether the instruction information includes information that is not allowed to be output to outside of the processing control apparatus; and
in a case where the instruction information includes the information that is not allowed to be output to the outside of the processing control apparatus, select a generative AI system included in the processing control apparatus.

8. The processing control apparatus according to claim 1, wherein
the one or more processors are further configured to execute the instructions to: select a generative AI system by using a threshold set for the estimated response time.

9. A processing control method comprising:
acquiring instruction information to be input to a generative AI system;
estimating a response time required to acquire response information related to the instruction information for each of a plurality of generative AI systems;
selecting a generative AI system that acquires the response information related to the instruction information based on the estimated response time; and
acquiring the response information related to the instruction information from the selected generative AI system by transmitting the instruction information to the selected generative AI system.

10. A non-transitory computer-readable recording medium storing a program for causing a computer to execute:
processing of acquiring instruction information to be input to a generative AI system;
processing of estimating a response time required to acquire response information related to the instruction information for each of a plurality of generative AI systems;
processing of selecting a generative AI system that acquires the response information related to the instruction information based on the estimated response time; and
processing of acquiring the response information related to the instruction information from the selected generative AI system by transmitting the instruction information to the selected generative AI system.
